(19) United States
(12) Patent Application Publication
(10) Pub. No.: US 2015/0309238 A1
(43) Pub. Date: Oct. 29, 2015

(54) A BACKLIGHT MODULE AND A DISPLAY DEVICE

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Xijun AN, Beijing (CN); Young Man KWON, Beijing (CN); Gang YANG, Beijing (CN)

(73) Assignees: BEIJING BOE OPTOELECTRONICS TECHNOLOGY CO., LTD., Beijing (CN); BOE TECHNOLOGY GROUP CO., LTD., Beijing (CN)

(21) Appl. No.: 14/408,037

(22) PCT Filed: Jun. 20, 2014
(86) PCT No.: PCT/CN2014/080447

§ 371 Date: Dec. 15, 2014

(30) Foreign Application Priority Data
Jan. 26, 2014 (CN) 201410037403.3

(51) Int. Cl. F21V 8/00

(52) U.S. Cl. CPC G02B 6/0031; G02B 6/005

(57) ABSTRACT

A backlight module comprising a light guide plate (3) and a glue frame on the periphery of the light guide plate (3), the light guide plate (3) comprising an light incoming surface (32) and a distal light surface (31) opposite to the light incoming surface (32), the glue frame comprising a first rim (11) facing the distal light surface (31) of the light guide plate (3), the first rim (11) comprising a first surface (111) facing the distal light surface (31) of the light guide plate (3), wherein the first surface (111) has a first microstructure. The backlight module efficiently improves light leak phenomenon while improving utility efficiency of light.

### TECHNICAL FIELD

Embodiments of the present disclosure relate to a backlight module and a display device.

### BACKGROUND

A liquid crystal device is advantageous in compactness, low consumption and low radiation etc. and has been widely applied to electronic apparatuses such as computer displays, laptop computers, cell phones and liquid crystal televisions. Since the display plate of the liquid crystal display is not luminescent itself, a backlight model is required to provide a light source. Currently, main components of the backlight module comprise a light emitting element, a reflecting plate, a light guide plate, a glue frame, a back plate, and etc, wherein, the light guide plate is configured for uniformly guiding the light emitted from the light emitting element upward and the structure and material thereof determine final brightness and uniformity of the backlight module; the glue frame is configured for jointing or positioning other components in the backlight module.

Referring to FIG. 1, the light guide plate 3′ is disposed below an optical film 2′ and comprises a light incoming surface 32′ and a distal light surface 31′ opposite to the light incoming surface, and the glue frame is provided at peripheries of the light guide plate 3′, wherein the glue frame provided on a side of the distal light surface 31′ of the light guide plate 3′ is a first rim 11′, the glue frame provided on a side of the light incoming surface 32′ of the light guide plate 3′ is a second rim 12′, the distal light surface 31′ of the light guide plate 3′ is disposed facing a first surface 111′ of the first rim 11′, and the light from the light emitting element enters the light guide plate 3′ at the light incoming surface 32′ of the light guide plate 3′, wherein a part of the light is totally reflected and transmitted toward the distal light surface, and exits at the distal light surface 31′ of the light guide plate 3′, so that a bright stripe is formed at the side of the distal light surface 31′, causing the display device to produce a bright belt. A solution known to the inventor is to block the light by means of a light shielding tape to prevent a bright belt from occurring. Since the light shielding tape is black, the light incident on the light shielding tape can be absorbed, but this results in a lower utility efficiency of the light.

### SUMMARY

One of technical problems to be solved by embodiments of the present disclosure is to provide a backlight module and a display device which improve utility efficiency of light in a case that a good display quality is maintained.

To solve the above technical problem, at least one embodiment of the present disclosure provides a backlight module comprising a light guide plate and a glue frame provided on peripheries of the light guide plate, the light guide plate comprising a light incoming surface and a distal light surface opposite to the light incoming surface, the glue frame comprising a first rim facing the distal light surface of the light guide plate, the first rim comprising a first surface facing the distal light surface of the light guide plate, wherein the first surface is provided with a first microstructure.

According to one embodiment of the present disclosure, the first microstructure has a structure in shape of jigsaw or a structure in shape of wave.

According to one embodiment of the present disclosure, the first microstructure comprises a plurality of first reflective structures arranged in an array.

According to one embodiment of the present disclosure, the first reflective structures have a semi-sphere shape with a diameter of 0.04 mm-0.05 mm

According to one embodiment of the present disclosure, the backlight module further comprises an optical film disposed above the light guide plate, the first rim further comprising a second surface facing the optical film, the second surface having a second microstructure.

According to one embodiment of the present disclosure, angle between the second surface and the outgoing surface of the light guide plate is larger than or equal to 10° and less than 90°.

According to one embodiment of the present disclosure, the second microstructure has a structure in shape of jigsaw or a structure in shape of wave.

According to one embodiment of the present disclosure, the second microstructure comprises a plurality of second reflective structures arranged in an array.

According to one embodiment of the present disclosure, the second reflective structures have a semi-sphere shape with a diameter of 0.04 mm-0.05 mm.

At least one embodiment of the present disclosure provides a display device, comprising any one of the above backlight modules.

In the embodiments of the present disclosure, the first surface of the first rim of a glue frame is provided with first microstructures which is capable of scattering the relatively concentrated light incident on the first surface so that the light is reflected to different directions, and the reflected light is not incident in a concentrated manner when the reflected light is incident on the light guide plate again, and thus a bright stripe is not formed on the side of the distal light surface of the light guide plate so that light leak phenomenon is improved, at the same time, since all or a part of the reflected light is reflected to the inner of the light guide plate by the first structures without reflecting the light out of the backlight source directly, light loss is reduced and the utility efficiency of the light is improved.

### BRIEF DESCRIPTION OF THE DRAWINGS

In order to clearly illustrate the technical solution of the embodiments of the invention, the drawings of the embodiments will be briefly described in the following; it is obvious that the described drawings are only related to some embodiments of the invention and thus are not limitative of the invention.

FIG. 1 is a diagram of a backlight module;

FIG. 2 is a diagram of a backlight module according to one embodiment of the present disclosure;

FIG. 3 is a diagram of another backlight module according to one embodiment of the present disclosure;

FIG. 4 is a diagram of another backlight module according to another embodiment of the present disclosure; and

FIG. 5 is a diagram of a first rim of the backlight module as illustrated in FIG. 4.

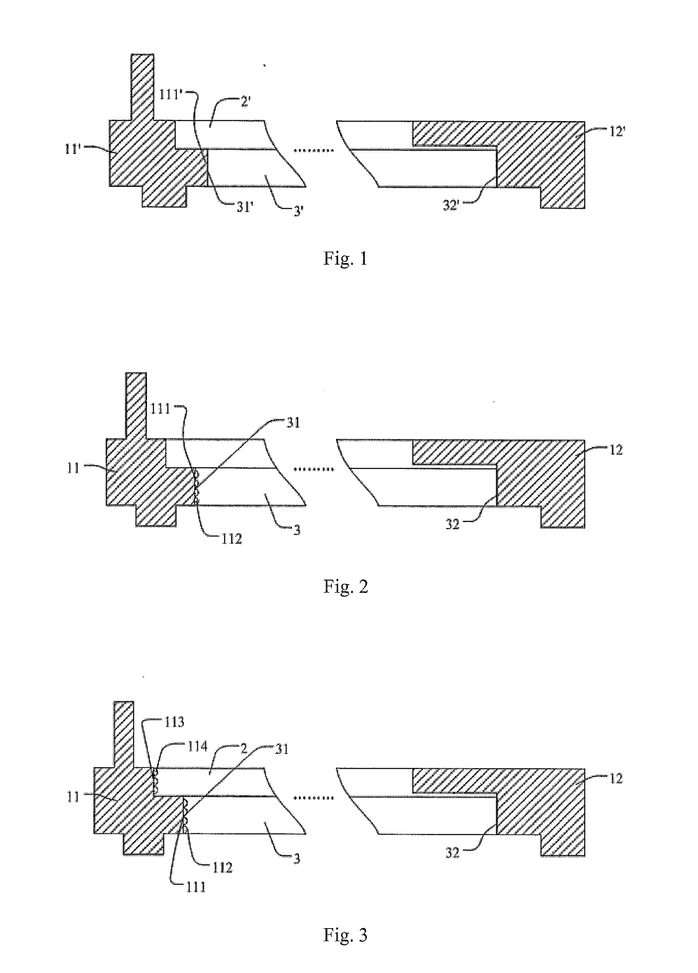

### DETAILED DESCRIPTION

In order to make objects, technical details and advantages of the embodiments of the invention apparent, the technical solutions of the embodiment will be described in a clearly and fully understandable way in connection with the drawings related to the embodiments of the invention. It is obvious that the described embodiments are just a part but not all of the embodiments of the invention. Based on the described embodiments herein, those skilled in the art can obtain other embodiment(s), without any inventive work, which should be within the scope of the invention

### Embodiment 1

The present embodiment provides a backlight module comprising a light guide plate and a glue frame provided on peripheries of the light guide plate, the light guide plate comprising a light incoming surface and a distal light surface opposite to the light incoming surface, the glue frame comprising a first rim facing the distal light surface of the light guide plate, the first rim comprising a first surface facing the distal light surface of the light guide plate, wherein the first surface is provided with a first microstructure which is configured to reflect light incident on the first microstructure to different directions.

In the embodiment, a first microstructure is provided on the first surface of the first rim of the glue frame, wherein the first microstructure can reflect the light incident on the surface relatively concentrated to different directions so that a bright stripe is not formed at the side of the distal light surface of the light guide plate and the first microstructure can reflect all or a part of the incident light to the inner of the light guide plate so that the light cannot be reflected out of the backlight source, in such a way that light leak phenomenon is improved and utility efficiency of light is improved.

### Embodiment 2

FIG. 2 is a diagram of a backlight module provided according to a second embodiment of the present disclosure, wherein the back light module comprises a light guide plate 3 and a glue frame provided on peripheries of the light guide plate, the light guide plate 3 comprising a light incoming surface 32 and a distal light surface 31 opposite to the light incoming surface 32, the glue frame comprising a first rim 11 facing the distal light surface 31 and a second rim 12 facing the light incoming surface 32, the first rim 11 comprising a first surface 111 facing to the distal light surface 31 of the light guide plate, wherein the first surface 111 is provided with a first microstructure which are configured to reflect light incident on the first microstructure to different directions. For example, when light within the light guide plate is incident on the first surface from the distal light surface 31, the light can be reflected irregularly to different directions by the first microstructure of the first surface and can prevent a bright line from being formed on the side of the distal light surface 31 so that a bright stripe will not be formed, and the first microstructure reflects all or a part of the incident light to the inner of the fight guide plate without reflecting the light out of the backlight source directly, so that light loss is lowered and in turn utility efficiency of light is improved.

The microstructure can have a structure in shape of jigsaw or a structure in shape of wave. Referring to FIG. 2, the first microstructure can be configured of a plurality of first reflective structures arranged in an array, that is, a plurality of first reflective structures 112 can be disposed on the first surface in an array. For example, the first reflective structures 112 have a semi-sphere shape with a diameter in a range of 0.04 mm-0.05 mm, for example, 0.04 mm, 0.041 mm, 0.043 mm, 0.045 mm, 0.047 mm, 0.049 mm or 0.05 mm. In addition, the first microstructures can be disposed on the first surface in other manners, for example, a plurality of prism with a triangular cross-section or semicircular columns can be disposed in parallel on the first surface so as to form the first microstructure.

### Embodiment 3

Referring to FIG. 3, which is a diagram of a backlight module according to the present embodiment, the backlight module comprises a light guide plate 3 and a glue frame provided on peripheries of the light guide plate, the light guide plate 3 comprises a light incoming surface 32 and a distal light surface 31 opposite to the light incoming surface 32, the glue frame comprises a first rim 11 facing the distal light surface 31 and a second rim 12 facing the light incoming surface 32, wherein the first rim 11 comprises a first surface 111 facing the distal light surface 31 of the light guide plate, and the first surface 111 is provided with a first microstructure which is configured to reflect light incident on the first microstructure to different directions, wherein the first rim 11 further comprises a second surface 113 facing an optical film 2, with the second surface 113 provided with second microstructure configured to reflect light incident on the second microstructure to different directions.

When light within the light guide plate is incident on the first surface from the distal light surface 31, the light can be reflected irregularly to different directions by the first microstructure of the first surface and can avoid a bright stripe to be formed at the side of the distal light surface 31 so that a bright stripe is prevented from being formed. And the first microstructure reflects all or a part of the reflected light to the inner of the light guide plate without reflecting the light out of the backlight source directly, so that light loss is lowered and in turn utility efficiency of light improves. In addition, the utility efficiency of light is further improved by providing the second microstructure on the second surface 113.

The second microstructure can be a structure in a shape of jigsaw or a structure in a shape of wave. Referring to FIG. 3, the second microstructure can be configured of a plurality of second reflective structures arranged in an array, that is, the second microstructure can be formed by providing a plurality of second reflective structures 114 in an array on the second surface. For example, the second reflective structure 114 has a shape of a semi-sphere with a diameter in a range of 0.04 mm-0.05 mm, for example, 0.045 mm, 0.049 mm or 0.05 mm. In addition, the second microstructure can be formed on the second surface in other manners, for example, a plurality of prism with a triangular section or semicircular columns are disposed in parallel on the second surface to form the second microstructure.

### Embodiment 4

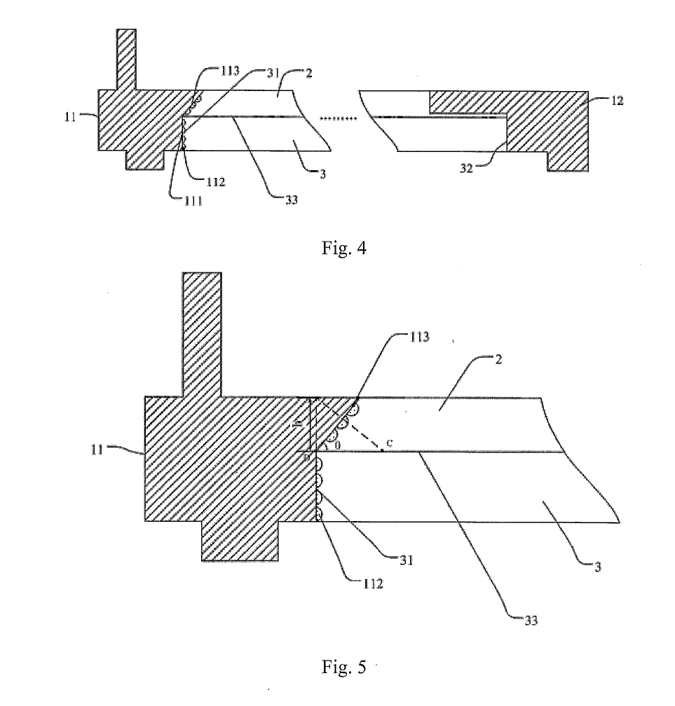

Referring to FIG. 4, which is diagram of a backlight module provided by the present embodiment, the backlight module comprises a light guide plate 3 and a glue frame on peripheries of the light guide plate. The light guide plate 3 comprises a light incoming surface 32 and a distal light surface 31 opposite to the light incoming surface 32. The glue frame comprises a first rim 11 facing the distal light surface 31 and a second rim 12 facing the light incoming surface 32, wherein the first rim 11 comprises a first surface 111 facing the distal light surface 31 of the light guide plate, and the first surface 111 is provided with a first microstructure which is configured for reflecting light incident on the first microstructure to different directions. And the backlight module further comprises an optical film 2 disposed above the light guide plate, wherein the first rim 11 further comprises a second surface 113 facing the optical film material 2, with the second surface 113 provided with a second microstructure configured for reflecting light incident on the second microstructure to different directions, wherein an angle between the second surface 113 and the outgoing surface 33 of the light guide plate 3 is greater than or equal to 10° and less than 90°, for example 30°, 50°, 70°, 80° and etc., that is, the second surface 113 can be disposed inclined so that light incident on the second surface can be reflected back to the light guide plate as more as possible, to improve the utility efficiency of light. For example, the inclined angle of the second surface 113 can be set according to the positions of spots with low brightness on the outgoing surface of the light guide plate, Referring to FIG. 5, when the angle between the second surface 113 and the outgoing surface of the light guide plate 3 is θ, h is a vertical height of the second surface 113, C is a spot with low brightness on the outgoing surface of the light guide plate, D is an intersecting line of the outgoing surface 33 and the second surface 113 of the light guide plate 3, then θ=90°—arctan(h/|CD|). By adjusting the inclined angle of the second surface according to θ, improvement of brightness to positions with low brightness is achieved.

Furthermore, for a backlight module of the above embodiments, it is possible to set the first microstructure and the second microstructure have a white or silver surface to further improve the utility efficiency of light.

In the backlight module provided by the embodiments of the present disclosure, the first microstructure is provided on the first surface of the first rim of a glue frame, the second microstructure is provided on the second surface, to reflect the light incident on the first surface and the second surface to different directions so that the reflected light is not incident in a concentrated manner when the reflected light is incident on the light guide plate again, and a bright stripe is not formed on the side of the distal light surface of the light guide plate so that light leak phenomenon is improved, and at the same time, since all or a part of the reflected light is reflected to the inner of the light guide plate, light loss is lowered and the overall brightness of the backlight module can be improved. Furthermore, by disposing the second surface inclined, improvement of brightness to positions with low brightness is achieved.

### Embodiment 5

The embodiment provides a display device comprising the backlight module according to any one of the embodiment 1-4, wherein, the display device can be any product or component with a display function, such as a laptop computer display screen, an electronic paper, an OLED display device, a liquid crystal display device, a liquid crystal television, a digital photo frame, a cell phone, a tablet computer and so on.

The foregoing are merely exemplary embodiments of the invention, but are not used to limit the protection scope of the invention. The protection scope of the invention shall be defined by the attached claims.

The present disclosure claims priority of Chinese Patent Application No. 201410037403.3 filed on Jan. 26, 2014, 2014, the disclosure of which is hereby entirely incorporated by reference.

1. A backlight module comprising a light guide plate and a glue frame at peripheries of the light guide plate, the light guide plate comprising a light incoming surface and a distal light surface facing the light incoming surface, the glue frame comprising a first rim facing the distal light surface of the light guide plate, the first rim comprising a first surface facing the distal light surface of the light guide plate, wherein the first surface has a first microstructure.

2. The backlight module according to claim 1, wherein, the first microstructure has a shape of a jigsaw or a wave.

3. The backlight module according to claim 1, wherein, the first microstructure comprises a plurality of first reflective structures arranged in an array.

4. The backlight module according to claim 3, wherein, the first reflective structures have a shape of a semi-sphere with a diameter of 0.04 mm-0.05 mm.

5. The backlight module according to claim 1, further comprising an optical film disposed above the light guide plate, the first rim further comprising a second surface facing the optical film, the second surface having a second structure.

6. The backlight module according to claim 5, wherein, angle between the second surface and an outgoing surface of the light guide plate is greater than or equal to 10° and less than 90°.

7. The backlight module according to claim 5, wherein, the second microstructure has a shape of a jigsaw or a wave.

8. The backlight module according to claim 5, wherein, the second microstructure comprises a plurality of second reflective structures arranged in an array.

9. The backlight module according to claim 8, wherein, the second reflective structures have a shape of a semi-sphere with a diameter of 0.04 mm-0.05 mm.

10. A display device, comprising the backlight module according to claim 1.

11. The backlight module according to claim 2, further comprising an optical film disposed above the light guide plate, the first rim further comprising a second surface facing the optical film, the second surface having a second structure.

12. The backlight module according to claim 3, further comprising an optical film disposed above the light guide plate, the first rim further comprising a second surface facing the optical film, the second surface having a second structure.

13. The backlight module according to claim 4, further comprising an optical film disposed above the light guide plate, the first rim further comprising a second surface facing the optical film, the second surface having a second structure.

14. The backlight module according to claim 6, wherein, the second microstructure has a shape of a jigsaw or a wave.
